(19) United States
(12) Patent Application Publication
(10) Pub. No.: US 2007/0256539 A1
(43) Pub. Date: Nov. 8, 2007

(54) Finger alignment training device

(76) Inventor: Mark E. Flynn, Clarence, NY (US)

Correspondence Address: SIMPSON & SIMPSON, PLLC, 5555 MAIN STREET, WILLIAMSVILLE, NY, 14221-5406, US

(21) Appl. No.: 11/800,325

(22) Filed: May 4, 2007

Related U.S. Application Data
(60) Provisional application No. 60/746,451, filed on May 4, 2006.

(51) Int. Cl. G09B 15/00; G09B 15/04; G09B 15/02

(52) U.S. Cl. 84/470 R

(57) ABSTRACT

A finger alignment device for a musical instrument, the alignment device includes an enclosure having a mounting surface and at least one open end, the enclosure arranged to substantially cover a fore end of a finger and a releasable fastening means for engaging with the instrument. In some embodiments, the musical instrument includes at least one valve and the releasable fastening means arranged on the mounting surface to releasably secure the enclosure on one of the at least one valve.

### CROSS-REFERENCE TO RELATED APPLICATIONS

This patent application claims the benefit under 35 U.S.C. § 119(e) of U.S. Provisional Application No. 60/746,451, filed May 4, 2006, which application is incorporated herein by reference.

### FIELD OF THE INVENTION

The invention broadly relates to training devices, more specifically to training devices for musical instruments, and even more particularly to a finger alignment training device for musical instruments.

### BACKGROUND OF THE INVENTION

Students learning to play musical instruments, in particular woodwind and brass instruments, must be taught where to position their fingers on the valves or keys of such instruments. Students have a tendency to allow their fingers to extend over the valve buttons or keys as they progress, thereby creating poor finger position. This lack of finger control causes tension in the hands, allows the fingers to disengage disproportionately above the valve or key resulting in unnecessary motion in the fingers and ultimately poor technical proficiency. Additionally, pressing down on a valve of an instrument using poor finger position pushes or pulls on the valve thereby forcing the valve out of alignment, and such misalignment creates uneven wear on the valve. Proper finger positioning, i.e., leaving the fingertip or fore end of the finger centered on the key or valve button without raising the fingertip off the valve or key, is crucial to the development of good technical proficiency on a musical instrument.

Many devices have been created to address the problem of poor finger/hand position on musical instruments. For example, devices such as finger rests have been used on recorders to assist in positioning of thumbs, while other devices have been used with open and closed hole flutes and clarinets to address vertical positioning of fingers. These devices are often complex and require that an apparatus be affixed to the body of the musical instrument, they may be large and obtrusive requiring significant time to attach and remove, and instruments having such devices installed thereon must be stored outside of the standard instrument case making them cumbersome for transport to and from instruction, practice and performance sites.

As can be derived from the variety of devices and methods directed at training finger positioning relative to valves on a musical instrument, many means have been contemplated to accomplish the desired end, i.e., proper and consistent placement of fingers. Heretofore, tradeoffs between complexity and convenience were required. Thus, there is a long-felt need for a finger alignment device for musical instruments which is easy to use and inexpensive to produce. There is a further long-felt need for a finger alignment device for musical instruments which does not alter the overall size and shape of the musical instrument.

### BRIEF SUMMARY OF THE INVENTION

The present invention broadly comprises a finger alignment device for a musical instrument, the alignment device including an enclosure having a mounting surface and at least one open end, the enclosure arranged to substantially cover a fore end of a finger and a releasable fastening means for engaging with the instrument. In some embodiments, the musical instrument includes at least one valve and the releasable fastening means arranged on the mounting surface to releasably secure the enclosure on one of the at least one valve, while in other embodiments, the musical instrument includes at least one drumstick and the releasable fastening means arranged on the mounting surface to releasably secure the enclosure on one of the at least one drumstick. In other embodiments, the releasable fastening means includes a hook and loop type fastener, while in still other embodiments, the releasable fastening means includes an adhesive, and in yet further embodiments, the releasable fastening means includes a snap connector. In some embodiments, the enclosure is a tubular enclosure adapted for the fore end of the finger having an open first end and at least a partially open second end opposite the open first end, while in other embodiments the enclosure is a tubular enclosure adapted for the fore end of the finger having a closed first end and an open second end opposite the closed first end, in yet other embodiments the enclosure is a tubular enclosure adapted for the fore end of the finger having an open first end and an open second end opposite the open first end, and in still yet other embodiments, the enclosure further includes a U-shaped wall integral to the mounting surface.

In some embodiments, the enclosure is constructed from a material selected from the group consisting of wood, metal, elastomer, polymer, ceramic, leather, rubber, cardboard, fiberglass, cloth and combinations thereof. In still further embodiments, the mounting surface is planar, while in other embodiments, the mounting surface is curved. In yet further embodiments, the enclosure is a tapered shape, while in still yet further embodiments the enclosure is a linear shape.

The present invention also broadly comprises a musical instrument including at least one valve, an enclosure having a mounting surface and at least one open end, the enclosure arranged to substantially cover a fore end of a finger and a releasable fastening means on the mounting surface arranged to releasably secure the enclosure on one of the at least one valve.

The present invention further broadly comprises a method of aligning a finger on a valve of a musical instrument, the method includes the steps of: (a) releasably securing an enclosure on the valve of the musical instrument; and, (b) inserting a fore end of the finger within the enclosure. In some embodiments, the enclosure includes a mounting surface and at least one open end, the enclosure arranged to substantially cover the fore end of the finger. In other embodiments, the enclosure is arranged to limit a distance of insertion of the fore end of the finger within the enclosure.

The present invention also broadly comprises a finger alignment kit for aligning respective fore ends of a plurality of fingers with a plurality of valves on a musical instrument, the alignment kit includes a plurality of enclosures wherein each enclosure has a mounting surface and at least one open end and is arranged to substantially cover the respective fore ends of the plurality of fingers and releasable fastening means for engaging with the instrument arranged on each of the plurality of enclosures.

It is a general object of the present invention to provide a device for training proper finger alignment while playing a musical instrument.

It is a further object of the present invention to provide a finger alignment training device having a universal design which applies to a variety of makes and models of musical instruments, and which attaches to a musical instrument, individual keys, valve buttons or valve stems of a musical instrument.

It is yet a further object of the present invention to provide a finger alignment training device which may be quickly and easily installed, removed, cleaned and reused by teachers, parents or music pupils of a variety of ages and ability levels.

It is still a further object of the present invention to provide a finger alignment training device which is non-obtrusive, may be used for practice or performance, is small enough to store in instrument cases and may be transferred from instrument to instrument.

It is still yet a further object of the present invention to provide a finger alignment training device which is finger specific for independent finger correction and can be removed one at a time as individual finger problems are corrected.

It is a further object of the present invention to provide a finger alignment training device which is inexpensive to manufacture, made of suitable material to deter breakage and may be customized with colors, designs or stickers.

It is a further object of the present invention to provide a finger alignment training device arranged for use with musical instruments, and in some embodiments brass and closed hole woodwind instruments.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of a present invention finger alignment device;

FIG. 2A is a top plan view of the finger alignment device of FIG. 1;

FIG. 2B is a top plan view of another embodiment of a present invention finger alignment device;

FIG. 3A is a side elevational view of the finger alignment device of FIG. 1;

FIG. 3B is a side elevational view of another embodiment of a present invention finger alignment device;

FIG. 4A is a cross-sectional view of the finger alignment device of FIG. 1 taken generally along line 4A-4A of FIG. 3A;

FIG. 4B is a cross-sectional view of another embodiment of a present invention finger alignment device;

FIG. 5 is a perspective view of the finger alignment device of FIG. 1 having a fore end of a finger inserted therein;

FIG. 6 is a perspective view of a musical instrument having several present invention finger alignment devices releasably secured thereon;

FIG. 7 is a perspective view of a plurality of valve stems having a present invention finger alignment device installed on one of said plurality of valve stems;

FIG. 8A is a perspective view of another embodiment of a present invention finger alignment device having an open first end and at least a partially open second end opposite said open first end;

FIG. 8B is a perspective view of yet another embodiment of a present invention finger alignment device having an open first end and an open second end opposite said open first end;

FIG. 8C is a perspective view of yet another embodiment of a present invention finger alignment device having a U-shaped wall integral to a mounting surface;

FIG. 9 is a cross sectional view of the finger alignment device of FIG. 8A taken generally along line 9-9 of FIG. 8A; and,

FIG. 10 is a perspective view of another musical instrument having several present invention finger alignment devices releasably secured thereon.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “enclosure” is synonymous with terms such as “sleeve”, “cot”, “pouch”, “cover sheath”, etc., and such terms may be used interchangeably as appearing in the specification and claims. Additionally, it should be appreciated that the terms “valve” and “valves”, typically used in conjunction with brass instruments, are synonymous with terms such as “key” or “keys”, typically used in conjunction with woodwind instruments, and such terms may be used interchangeably as appearing in the specification and claims. It should also be appreciated that the term “drumstick” is synonymous with terms such as “timpani mallets”, and such terms may be used interchangeably as appearing in the specification and claims. Although any methods, devices or materials similar or equivalent to those described herein can be used in the practice or testing of the invention, the preferred methods, devices, and materials are now described.

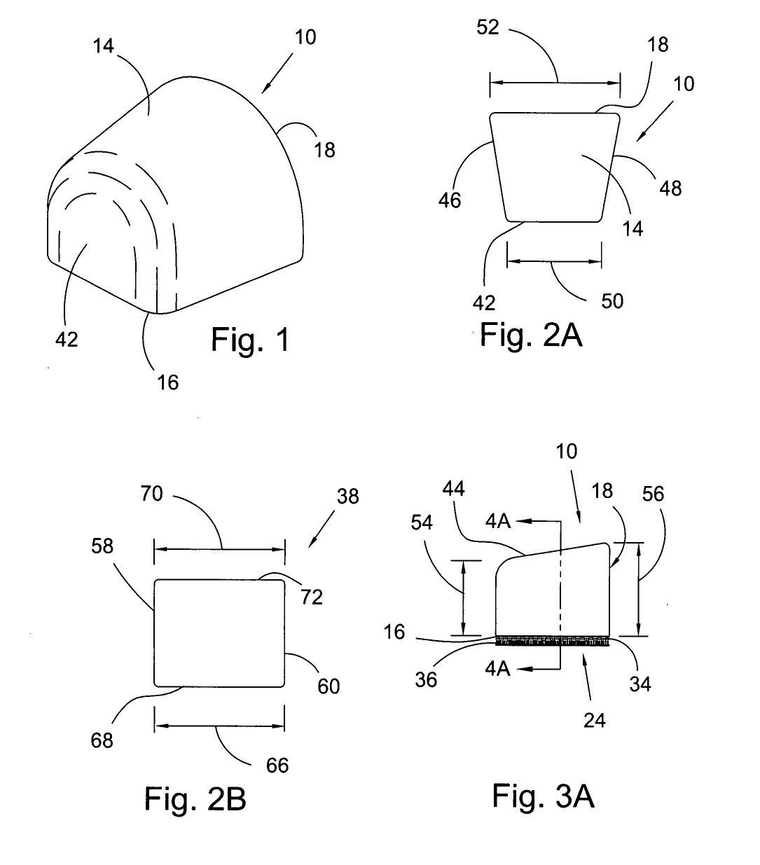

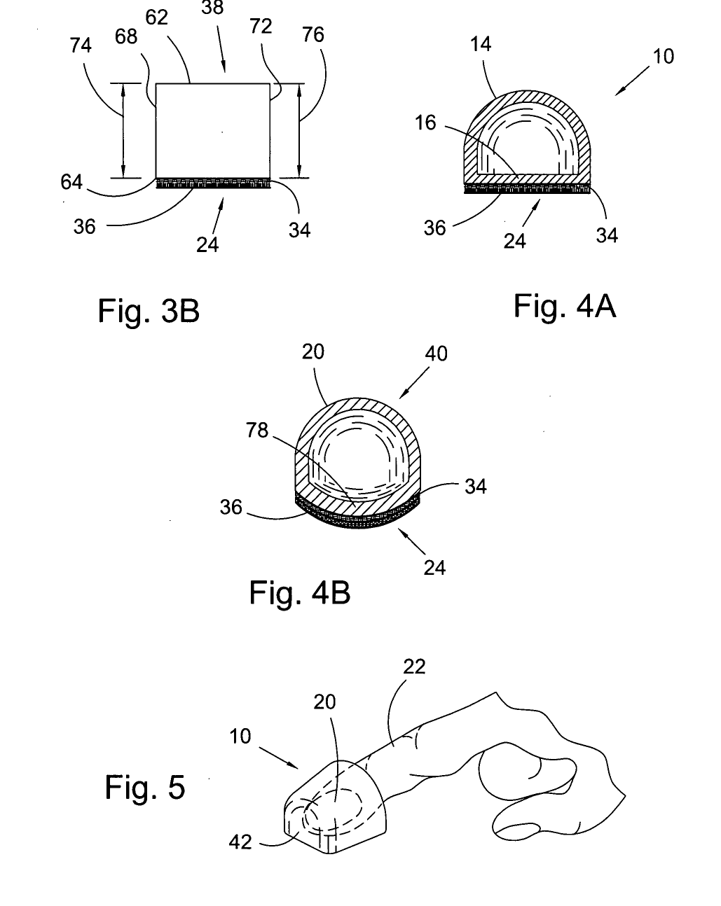

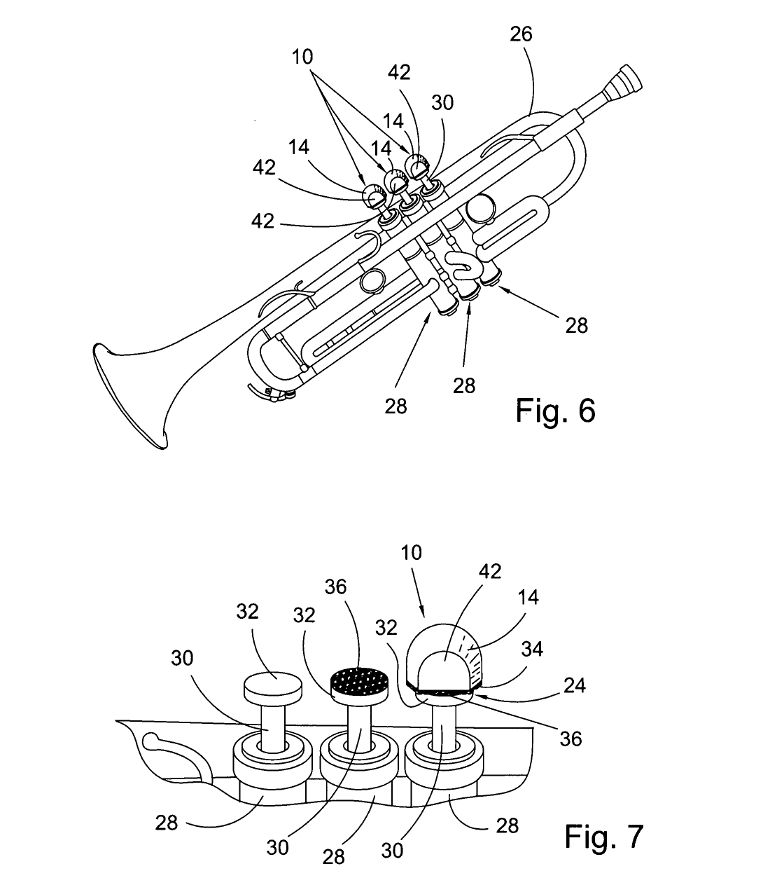

Adverting now to the figures, FIG. 1 shows a perspective view of present invention finger alignment device 10, FIG. 2A shows a top plan view of finger alignment device 10, FIG. 3A shows a side elevational view of finger alignment device 10, FIG. 4A shows a cross-sectional view of finger alignment device 10 taken generally along line 4A-4A of FIG. 3A, FIG. 5 shows a perspective view of finger alignment device 10 having a fore end of a finger inserted therein, and FIG. 6 shows a perspective view of a musical instrument having several present invention finger alignment devices 10 releasably secured thereon. The following discussion is best understood in view of FIGS. 1, 2A, 3A, 4A, 5 and 6.

Finger alignment device 10 is operatively arranged for use with a musical instrument as discussed in further detail infra. Alignment device 10 comprises enclosure 14, while enclosure 14 comprises mounting surface 16 and open end 18. Although the embodiment of alignment device 10 shown in these figures has a single open end 18, other arrangements are also possible, e.g., a first open end opposite a second open end, and such embodiments are discussed in further detail infra. Enclosure 14 is arranged to substantially cover fore end 20 of finger 22. Finger alignment device 10 further comprises releasable fastening means 24 for engaging device 10 with instrument 26.

FIG. 7 shows a perspective view of a plurality of valve stems having a present invention finger alignment device 10 installed on one of the plurality of valve stems. The following discussion is best understood in view of FIGS. 1, 2A, 3A, 4A, 5, 6 and 7. As can be seen in FIG. 6, musical instrument 26 comprises at least one valve 28, and in this instance three valves 28. Releasable fastening means 24 is arranged on mounting surface 16 to releasably secure enclosure 14 on one of valves 28. In the embodiment shown in FIG. 6, musical instrument 26 is a trumpet and as such valves 28 each include stem portion 30 having valve button 32 individually disposed thereon. In order to vary the notes played on instrument 26, valves 28 are depressed in various combinations, e.g., all valves open to one note or middle valve 28 depressed for a different note, and as described supra, the positioning of one's fingers on valve buttons 32 is critical to the proper actuation of valves 28. Hence, finger alignment devices 10 are positioned on valves 28 in such a way as to assist with proper finger positioning, and releasable fastening means 24 provides for such placement of devices 10. In the embodiments shown in the figures, the finger alignment devices are positioned on the center of the valve for proper operation of the musical instrument. Subsequent to installing the finger alignment devices, a user inserts a fore end of a finger within an alignment device until the fore end contacts the end/wall opposite the open end, and presses down with the fore end upon the inner surface of the mounting surface. Additionally, the finger alignment devices may be rotated, i.e., adjusted directionally on the valve, to correct a user's individual finger problems, thus customizing each alignment device's placement for individual comfort and finger size.

In the embodiment shown in these figures, releasable fastening means 24 comprises a hook and loop type fastener, i.e., hook portion 34 and loop portion 36. Both hook portion 34 and loop portion 36 include an adhesive layer whereby hook portion 34 is fixedly secured to mounting surface 16 and similarly loop portion 36 is fixedly secured to valve button 32. This arrangement permits the variable placement of finger alignment devices 10 on valve buttons 32, i.e., devices 10 may be positioned according to an individual's specific finger length and/or orientation. Although in the embodiment shown in these figures, releasable fastening means 24 comprises a hook and loop type fastener, i.e., hook portion 34 and loop portion 36, other releasable fastening means are also possible, e.g., an adhesive or a snap connector. Additionally, each respective releasable fastening means may be affixed to the alignment device and valve via an adhesive, for example, a glue or a double sided tape, and such alterations are within the spirit and scope of the claimed invention. Alternatively, the alignment devices may be attached to the valve buttons or keys via a track secured to the valve buttons or keys and a complimentary track secured to the alignment devices, i.e., the tracks slide into one another and lock in place. Further, the alignment device may be integral to the valve buttons or keys, thereby providing a replacement for traditional valve buttons and keys.

Furthermore, the present invention also broadly comprises musical instrument 26 including at least one valve 28, enclosure 14 and releasable fastening means 24. Enclosure 14 comprises mounting surface 16 and at least one open end, i.e., open end 18, and is arranged to substantially cover fore end 20 of finger 22. As described supra, releasable fastening means 24 is fixedly secured to mounting surface 16 and arranged to releasably secure enclosure 14 on one of valves 28.

FIG. 2B shows a top plan view of a second embodiment of a present invention finger alignment device, i.e., alignment device 38, while FIG. 3B shows a side elevational view of finger alignment device 38. FIG. 4B shows a cross-sectional view of another embodiment of a present invention finger alignment device, i.e., alignment device 40. The following discussion is best understood in view of FIGS. 1 through 5.

As can be seen in the figures, enclosure 14 is a tubular enclosure adapted for fore end 20 of finger 22 having closed first end 42 and open second end 18 opposite closed first end 42. In some embodiments, for example as shown in FIGS. 2A and 3A, enclosure 14 is a tapered shape, and such tapering may include tapering of first side 46 relative to second side 48 and/or tapering of top surface 44 relative to mounting surface 16. In other words, as shown in FIG. 2A, length 50 of closed first end 42 is less than length 52 of open second end 18, thereby providing a taper between first and second sides 46 and 48, respectively. Similarly, as shown in FIG. 3A, height 54 of closed first end 42 is less than height 56 of open second end 18, thereby providing a taper between top surface 44 and mounting surface 16.

As can be seen in FIGS. 2B and 3B, in some embodiments enclosure 38 is a linear shape, i.e., first side 58 is parallel to second side 60 and/or top surface 62 is parallel to mounting surface 64. In other words, as shown in FIG. 2B, length 66 of closed first end 68 is equal to length 70 of open second end 72, thereby providing a parallel relationship between first and second sides 58 and 60, respectively. Similarly, as shown in FIG. 3B, height 74 of closed first end 68 is equal to height 76 of open second end 72, thereby providing a parallel relationship between top surface 62 and mounting surface 64.

As can be seen in FIGS. 4A and 4B, the mounting surface has several embodiments. For example, FIG. 4A shows an embodiment of alignment device 10 having planar mounting surface 16, while FIG. 4B shows an embodiment of alignment device 40 having curved mounting surface 78. Additionally, in a preferred embodiment, present invention finger alignment devices, e.g., devices 10, 38 and 40, are constructed from a plastic material and are molded according to the arrangement described above, although other materials of construction are also possible, e.g., wood, metal, elastomer, polymer, ceramic, leather, rubber, cardboard, fiberglass, cloth and combinations thereof, and such materials are within the spirit and scope of the claimed invention.

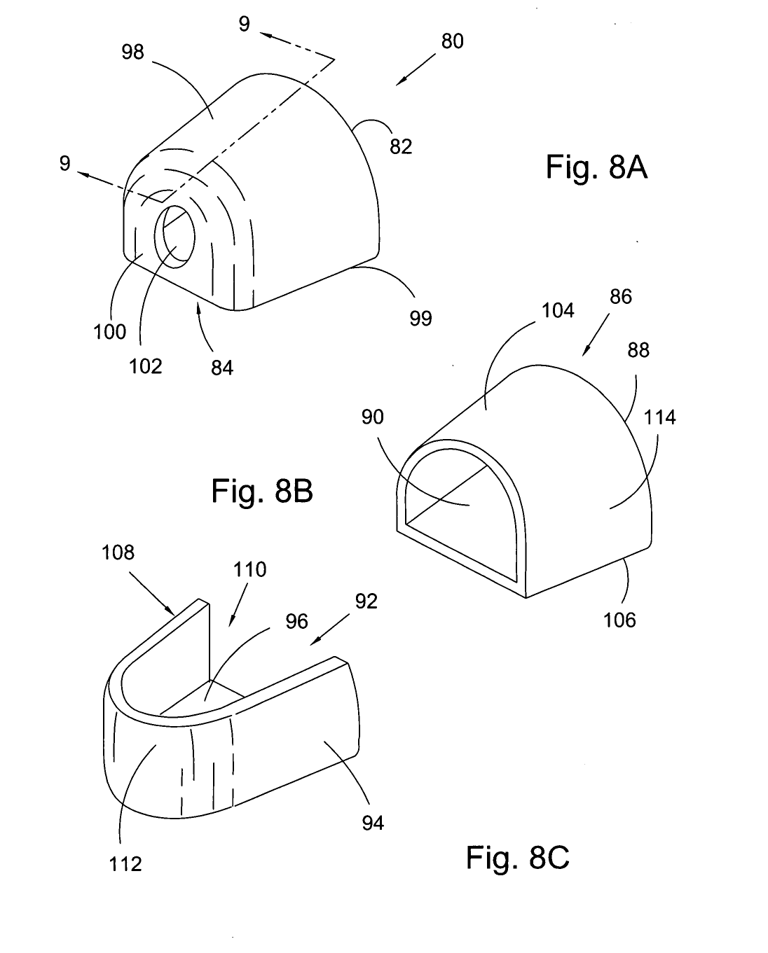

Other embodiments of the instant invention have also been contemplated, for example, FIG. 8A shows a perspective view of another embodiment of a present invention finger alignment device, i.e., alignment device 80 having open first end 82 and at least partially open second end 84 opposite open first end 82, FIG. 8B shows a perspective view of yet another embodiment of a present invention finger alignment device, i.e., alignment device 86, having open first end 88 and open second end 90 opposite open first end 88, while FIG. 8C shows a perspective view of yet another embodiment of a present invention finger alignment device, i.e., alignment device 92, having U-shaped wall 94 integral with mounting surface 96.

In the embodiment shown in FIG. 8A, finger alignment device 80 comprises enclosure 98 having mounting surface 99. Enclosure 98 is a tubular enclosure adapted for a fore end of a finger, as described supra, having an open first end 82 and at least partially open second end 84 opposite open first end 82. At least partially open second end 84 comprises wall 100 having opening 102 disposed therethrough. Contrarily, in the embodiment shown in FIG. 8B, finger alignment device 86 comprises enclosure 104 having mounting surface 106. Enclosure 104 is a tubular enclosure adapted for a fore end of a finger having open first end 88 and open second end 90 opposite open first end 88. In this embodiment, enclosure 104 does not include a closed end opposite an open end, or an at least partially open end opposite an open end. A further embodiment of the present invention, i.e., finger alignment device 92 shown in FIG. 8C, comprises enclosure 108 having mounting surface 96. In this embodiment, enclosure 108 is a substantially U-shaped enclosure comprising U-shaped wall 94 integral to mounting surface 96. Finger alignment device 92 further comprises open end 110 and closed end 112 opposite open end 110. The embodiments shown in FIGS. 8A through 8C support several teaching philosophies, e.g., finger pad and finger tip manipulation of the valve buttons and/or keys. In short, finger pad manipulation utilizes the pad of the finger to actuate the valve button and/or key, while finger tip manipulation utilizes the tip, or fore end, of the finger to actuate the valve button and/or key.

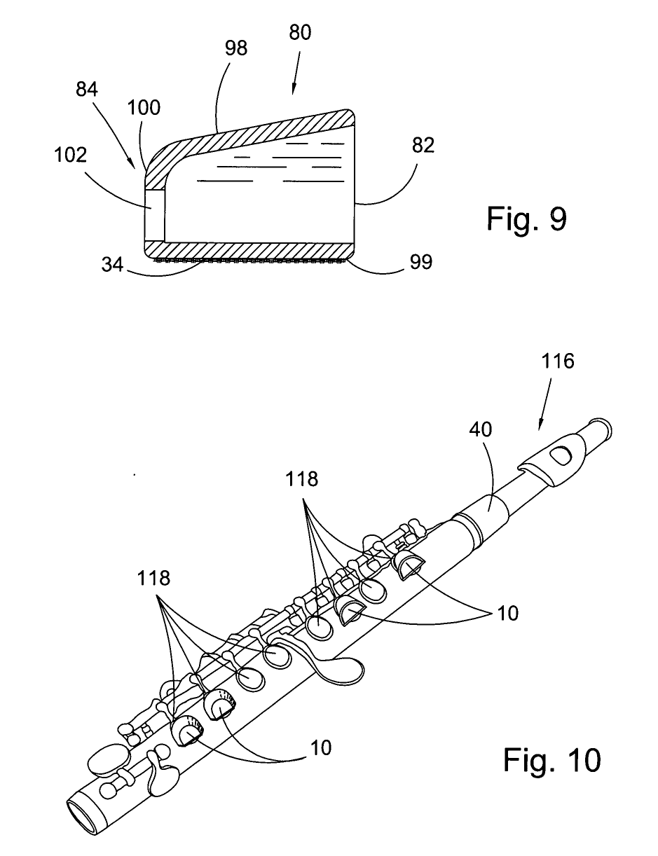

FIG. 9 shows a cross sectional view of finger alignment device 80 taken generally along line 9-9 of FIG. 8A. In this embodiment, as a user of the device inserts a fore end of a finger within enclosure 98, i.e., inserts a fore end of a finger through open end 82, wall 100 limits the forward movement of the fore end of the finger, thereby properly aligning the finger relative to a valve having alignment device 80 installed thereon. Opening 102 provides for the flow of air through enclosure 98, thereby aiding in the cooling of the fore end of the finger disposed therein, as well as aiding in drying any perspiration that may accumulate during use. This embodiment supports the teaching philosophy that favors finger pad manipulation of the valve button or key.

Similarly, alignment device 86, shown in FIG. 8B, comprises open second end 90. Open second end 90 provides similar benefits as opening 102, however in this embodiment, the insertion of a fore end of a finger is not limited by a wall located opposite open first end 88. Contrarily, the size of the opening within enclosure 104, i.e., the volume created by mounting surface 106 and wall 114, limits the insertion of a fore end of a finger. In other words, as a user inserts her finger within enclosure 104, interference between the fore end of the finger and wall 114 and mounting surface 106 prevents the user from inserting her finger beyond the position of proper alignment. This embodiment supports the teaching philosophy that favors finger pad manipulation of the valve button or key.

Furthermore, in the embodiment shown in FIG. 8C, alignment device 92 is shown including enclosure 108 which comprises mounting surface 96 and integral U-shaped wall 94. Closed end 112 provides a limit for the insertion of a fore end of a finger, and as with the aforementioned embodiments, this embodiment provides increased air flow about the fore end of the finger inserted within enclosure 108. Thus, some users of this device will prefer this arrangement as it allows the fore end of the finger to remain less constricted. Additionally, as instrument valves are typically spring loaded, after depression of a valve, merely removing pressure from one's finger, i.e., lifting the finger up, will restore the valve to its original position. Thus, an upper wall is not necessary to provide means for a user to lift a valve after actuating the valve. This embodiment supports the teaching philosophy that favors fingertip manipulation of the valve button or key.

The present invention finger alignment device typically has a depth and height sized to accommodate an average size finger, measured from the top knuckle to the tip. However, other sizes are also possible, e.g., enclosure sizes available for a variety of finger sizes. Additionally, the interior and exterior surfaces of the various embodiments of the finger alignment device may be textured, smooth, glossy or combinations thereof.

In addition to the present invention being arranged to be used on brass instruments, e.g., trumpet, trombone, french horn, euphonium, tuba, comet, flugle horn, baritone horn, sousaphone, mellophone and saxhorn, the present invention may also be used in combination with other wind instruments, e.g., wood winds such as flutes, single-reed instruments such as saxophones and clarinets, or double-reed instruments such as oboes and bassoons. On closed holed flute, saxophone, bass and alto clarinet instruments, multiple alignment devices may be secured to the most frequently used keys, while on other brass instruments, e.g., tuba, sousaphone, baritone and french horn, placement varies depending on the size of the valves or on rotary valves keys where the finger approaches the valve. On open holed devices, e.g., bassoons and oboes, present invention alignment devices may be used on the closed hole keys. When the present invention finger alignment devices are used on an instrument that has multiple pinky keys manipulated by the same pinky, e.g., flute, saxophone, bass or alto clarinet, one pinky key must be chosen to affix an alignment device, however the alignment device may be removed and reaffixed to a desired key. Because more than one key will often need to be manipulated by the same finger, use on woodwind instrument pinky keys is for practice and instructional purposes, not for performances. The alignment device may be used on a trombone slide by attaching two devices sideways on the support bar for the slide where a student would place their finger tips. A similar application may be used on a drumstick for proper finger and thumb position. FIG. 10 shows a perspective view of musical instrument 116 having several present invention finger alignment devices 10 releasably secured to keys 118 located thereon.

The present invention also broadly comprises a method of aligning a finger on a valve of a musical instrument. The method comprises the step of releasably securing an enclosure, e.g., alignment device 10, 38, 40, 80, 86 or 92, on the valve of the musical instrument, e.g., valve 28 or key 118. Subsequent to releasably securing the enclosure, a user of the present invention finger alignment device inserts a fore end of a finger, e.g., fore end 20 of finger 22, within the enclosure. As in some of the embodiments described supra, the enclosure comprises a mounting surface, e.g., mounting surfaces 16, 64, 78, 96, 99 or 106, and at least one open end, e.g., open end 18, 72, 82, 88 or 110, wherein the enclosure is arranged to substantially cover the fore end of the finger. Similarly, the enclosure is arranged to limit a distance of insertion of the fore end of the finger within the sleeve, as described supra.

Additionally, the present invention broadly comprises a finger alignment kit for aligning respective fore ends of a plurality of fingers with a plurality of valves on a musical instrument, the alignment kit includes a plurality of enclosures wherein each enclosure comprises a mounting surface and at least one open end and is arranged to substantially cover the respective fore ends of the plurality of fingers, and releasable fastening means for engaging with the instrument, arranged on each of the plurality of enclosures. A further advantage of the present invention finger alignment kit is that individual fingers may be corrected. The alignment kit allows for each device to be removed at desired intervals of training until all the individual finger positions are corrected. Also unique to the system is that if a problem reoccurs in any finger, one or multiple alignment devices may be reattached. Additionally, the soft portion, i.e., the loop portion, of the hook and loop fastener remains on the key or valve button, without interfering with the use of the key or valve button, until the problem has been corrected. The loop portion provides comfort, prevents slipping of sweaty fingers from valves and indicates to beginning students where to properly place their fingers, e.g., on a saxophone or flute.

The present invention finger alignment device may be used in combination with stickers. For example, a graduated improvement system color coded for advancement, individual creativity and decoration, to denote specific placement of the device on a key or valve button or to associate colors to notes for rote learning. Similarly, a number or letter system can be used to set each alignment device to a particular valve button or key and arrows can be placed on the device of proper alignment. Furthermore, the device and/or releasable fastening means can also be color specific for use by marching bands and drum corps for additional visual effects in performance competitions.

In view of the foregoing, the present invention finger alignment devices may be used to correct horizontal and vertical positioning of fingers relative to instrument valves, as well as correct angular positioning of fingers. The alignment device is easy to use, affordable, easy to clean, and may be used on closed holed woodwinds, all valve or key instruments as well as drumsticks. The alignment device promotes downward motion of valves and keys while maintaining stationary positioning on the valves or keys. In all applications, the result is positive muscle memory in the fingers resulting in the attainment of faster technical proficiency on a musical instrument over prolonged use.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What I claim is:

1. A finger alignment device for a musical instrument, said alignment device comprising:
an enclosure comprising a mounting surface and at least one open end, said enclosure arranged to substantially cover a fore end of a finger; and,
a releasable fastening means for engaging with said instrument.

2. The finger alignment device of claim 1 wherein said musical instrument comprises at least one valve and said releasable fastening means arranged on said mounting surface to releasably secure said enclosure on one of said at least one valve.

3. The finger alignment device of claim 1 wherein said releasable fastening means comprises a hook and loop type fastener.

4. The finger alignment device of claim 1 wherein said releasable fastening means comprises an adhesive.

5. The finger alignment device of claim 1 wherein said releasable fastening means comprises a snap connector.

6. The finger alignment device of claim 1, wherein said enclosure is a tubular enclosure adapted for said fore end of said finger having an open first end and at least a partially open second end opposite said open first end.

7. The finger alignment device of claim 1, wherein said enclosure is a tubular enclosure adapted for said fore end of said finger having a closed first end and an open second end opposite said closed first end.

8. The finger alignment device of claim 1, wherein said enclosure is a tubular enclosure adapted for said fore end of said finger having an open first end and an open second end opposite said open first end.

9. The finger alignment device of claim 1, wherein said enclosure further comprises a U-shaped wall integral to said mounting surface.

10. The finger alignment device of claim 1, wherein said enclosure is constructed from a material selected from the group consisting of wood, metal, elastomer, polymer, ceramic, leather, rubber, cardboard, fiberglass, cloth and combinations thereof.

11. The finger alignment device of claim 1, wherein said mounting surface is planar.

12. The finger alignment device of claim 1, wherein said mounting surface is curved.

13. The finger alignment device of claim 1, wherein said enclosure is a tapered shape.

14. The finger alignment device of claim 1, wherein said enclosure is a linear shape.

15. A musical instrument comprising:
at least one valve;
an enclosure comprising a mounting surface and at least one open end, said enclosure arranged to substantially cover a fore end of a finger; and,
a releasable fastening means on said mounting surface arranged to releasably secure said enclosure on one of said at least one valve.

16. A method of aligning a finger on a valve of a musical instrument, said method comprising the steps of:
(a) releasably securing an enclosure on said valve of said musical instrument; and,
(b) inserting a fore end of said finger within said enclosure.

17. The method of aligning a finger on a valve of a musical instrument of claim 16 wherein said enclosure comprises a mounting surface and at least one open end, said enclosure arranged to substantially cover said fore end of said finger.

18. The method of aligning a finger tip on a valve stem of a musical instrument of claim 16, wherein said enclosure is arranged to limit a distance of insertion of said fore end of said finger within said enclosure.

19. A finger alignment kit for aligning respective fore ends of a plurality of fingers with a plurality of valves on a musical instrument, said alignment kit comprising:
a plurality of enclosures wherein each enclosure comprises a mounting surface and at least one open end and is arranged to substantially cover said respective fore ends of said plurality of fingers; and,
releasable fastening means for engaging with said instrument arranged on each of said plurality of enclosures.
